(19) United States
(12) Patent Application Publication
(10) Pub. No.: US 2005/0143130 A1
(43) Pub. Date: Jun. 30, 2005

(54) Terminal, base station and method for a cellular network

(76) Inventor: Kari Horneman, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/503,403

(22) PCT Filed: May 31, 2002
(86) PCT No.: PCT/IB02/01955

(51) Int. Cl. H04B 1/38

(52) U.S. Cl. 455/561; 455/552.1

(57) ABSTRACT

A base station (1) of a cellular network (9) having a dividing means (2) for dividing data (4) intended for an user terminal (U1) into data packets (DP1-DP4) and a selecting means (7) for selecting at least one of the user terminals (U2-U4) of said cellular network (9). Thereby, the selecting means (7) selects user terminals which are connected or are able to connect to said user terminal (U1) via a second network (6). Further, the base station (1) comprises a sending means (8) for sending at least one of said data packets (DP1-DP4) to said user terminals selected (U2-U4) over said cellular network. Also, a terminal of the user (U1) receiving the data (4) and a method of the receiving is comprised.

### FIELD OF THE INVENTION

The present invention relates to a communication method of a cellular network, and to a terminal and base station for such.

### BACKGROUND OF THE INVENTION

A cellular network offers large coverage areas and high terminal mobility. Thereby, even moving terminals are able to connect to the cellular network. But the data rate is limited by the usable cell size and the speed of the moving terminals. Therefore, higher data rates are only usable close to the base station with pedestrian speeds. So, in high moving vehicles it is impossible to use very high data rates.

To increase the data rate, an asymmetric utilization in up-link and down-link can be used. Thereby, a higher data rate for down-link can be provided, if up-link data rates are decreased accordingly. But, this asymmetric data transfer cannot increase the overall data rate.

### SUMMARY OF THE INVENTION

It is therefore the object of the present invention, to increase the data rate for a selected user terminal, especially if this user is moving.

The object is solved by a base station according to claim 1 or 6, by a terminal according to claim 9 or 18 and by a method according to claim 26 or 33. Advantageous developments of the invention are mentioned in the dependent claims.

Throughout this application words user terminal and terminal are used for describing the terminal equipment, which may be related to a specific user. A user terminal can be in example a cellular phone, a PDA, a mobile router, or any other mobile communication apparatus capable of receiving, handling and sending data in accordance to this method and system. A terminal can be also for instance a mobile router equipment, which may or may not be associated to a specific user.

The terminal should be understood as any kind of terminal capable of functioning in accordance to the specified claims.

The apparatus and the method of the invention have the advantage that data which is intended for an specific terminal is distributed over at least two terminals so that idle terminals or terminals that do not utilizise the maximum data rate can be used as an additional passage for data packets of the data. Therefore, the overall data rate increases with the terminals concerned with the shared data transmission. Thereby, the invention makes use of a second network between the terminals to transfer the data packets to/from the specific terminal.

According to an advantageous development, one data packet is sent directly between the cellular network base station and the specific terminal, and the other data packets are sent over other available terminals.

According to another advantageous development, terminals of the cellular network which are near the terminal for which the data is intended are selected. Then, the second network can be provided as an low-range network so that high data rates can be used.

According to a further advantageous development, terminals of the cellular network which are moving together with the terminal for which the data is intended are selected. Then the relative speed between the terminal for which the data is intended and the other selected terminals is slow so that high data rates can be achieved.

### BRIEF SUMMARY OF THE ACCOMPANIED DRAWINGS

The invention is further described in detail with relation to the accompanying drawings, in which:

FIG. 1 to 3 show flow charts of a method according to a first embodiment of the invention;

FIG. 4 to 6 show flow charts of a method according to a second embodiment of the invention;

FIG. 7 shows a schematic structure of base station and users according to the first embodiment of the invention;

FIG. 8 shows a receiving terminal of FIG. 7 according to the first embodiment of the invention in greater detail;

FIG. 9 shows a sending terminal according to the second embodiment of the invention;

FIG. 10 shows a schematic structure of base station and user terminals according to the second embodiment of the invention; and

FIG. 11 shows two users according to a third embodiment of the invention.

### DESCRIPTION OF THE PREFERRED EMBODIMENTS OF THE INVENTION

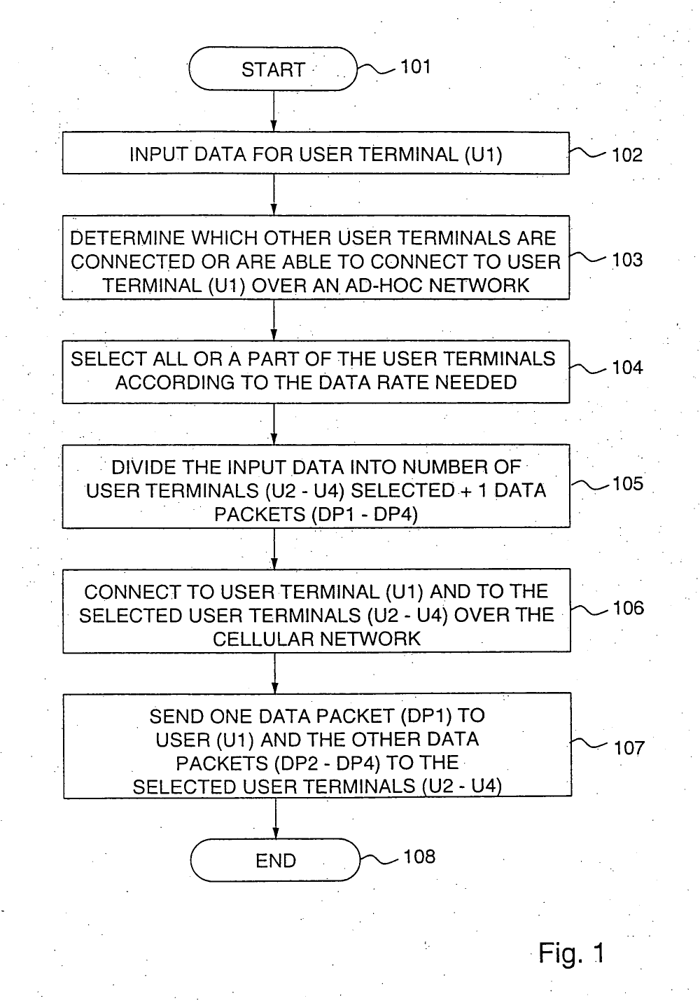

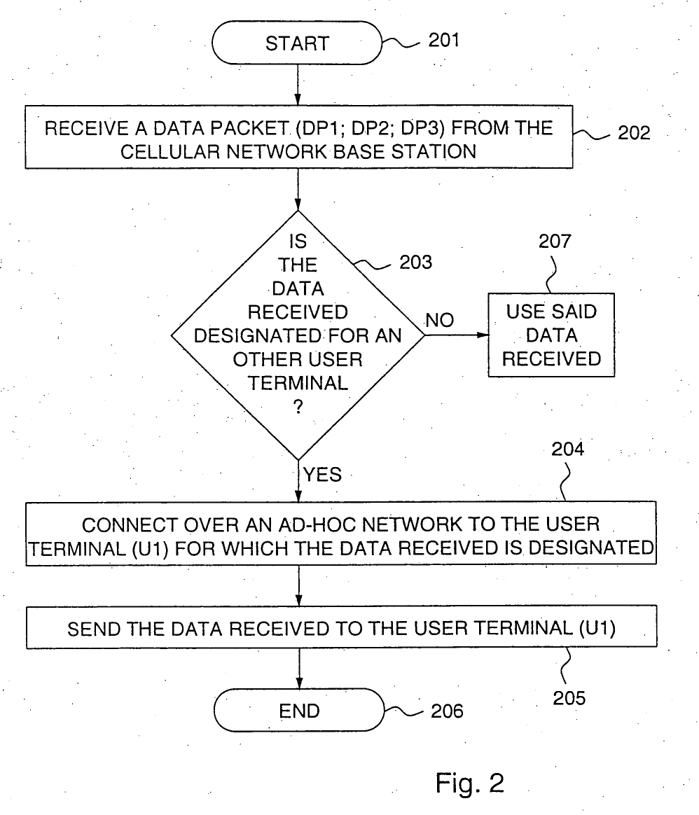

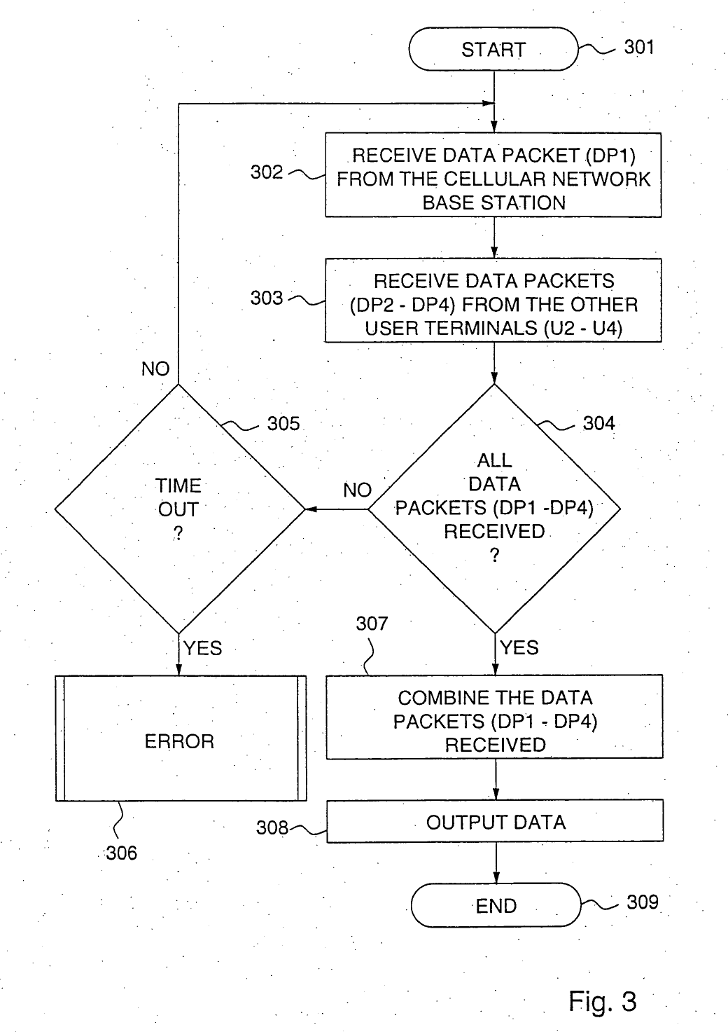

FIG. 1 to 3 show flow charts of a method for sending data from a base station of a cellular network to a specific user terminal (down-link). FIG. 1 shows the steps performed on the side of the base station, FIG. 2 shows the steps performed on the side of a user selected for forward transmission, and FIG. 3 shows the steps performed on the side of the user for which the data is intended.

In step 101 the procedure performed by the base station is started, and, as shown in step 102, input data for an user terminal U1 is received from the cellular network. Then, in step 103 it is determined which other user terminals are connected or are able to connect to user terminal U1 over a second network. In the first embodiment of the invention the second network is an ad-hoc network of low range so that preferably only the part of the user terminals, which is close to user terminal U1, are selected in the following step 104. The number of selected other user terminals U2 to U4 depends also on the data rate needed between the base station and the user terminal U1.

Step 104 is followed by step 105, in which the input data is divided in data packets DP1 to DP4, whereby one data packet DP1 is for the user terminal U1 and the other three data packets DP2 to DP4 are for the selected other user terminals U2 to U4.

The number of three user terminals selected is only intended as an exemplary example. In general, in step 104 any number of user terminals determined in step 103 can be selected. The input data is then divided in this number incremented by 1 data packets in step 105, whereby the additional one data packet is for the user terminal U1.

Step 105 is followed by step 106, in which a connection is established between the cellular network base station and the user terminal U1 and the selected other user terminals U2 to U4. This may be done according to any known, or future cellular network procedures. Connecting methods used in cellular network are not an essential part of this invention, and the specific methods for establishing a connection over a cellular network between the base station and the terminals are therefore omitted. The description of creating this connection is therefore simplified to the essence of that a connection is established between the base station and each terminal participating this system and method. After connecting to the user terminals U1 to U4, one data packet DP1 is sent to user terminal U1 and the other data packets DP2 to DP4 are sent to the other user terminals U2 to U4, as shown in step 107. Thereafter, the procedure ends in step 108.

In step 107 the data packets DP1 to DP4 can be sent as several subblocks. Thereby the data packets to each of the user terminals U1 to U4 are sent in parallel so that the effective data rate is at most the data rate for a single user terminal multiplied with the number of connected user terminals U1 to U4.

FIG. 2 shows a flow chart of the method performed by each of the terminals of the users U2 to U4.

The method is starting in step 201 after the connection is established between the base station and the respective user terminal. Then, a data packet DP2; DP3; DP4 is received from the base station, as shown in step 202. In step 203 it is determined, whether the data received is designated for another user terminal or for this terminal. If the data received is not designated for another user terminal, the data received is used, as shown in step 207. If the data received is designated for another user terminal, then the user terminal U1 for which the data received is designated is connected over a second network, whereby in this embodiment the second network is a low-range ad-hoc network (step 204). After connecting to user terminal U1, the data received in step 202 is sent to user terminal U1 in step 205, and the method ends in step 206.

The selection of the terminals contacted to this second network can alternatively be initiated before the actual data sending procedure is started, or any data packets intended for another user terminal U1 in the second network are received by the other user terminals U2-U4. This implicates that step 204 is performed prior to step 201. Establishment of the connection over network 2 can take place i.e. with any suitable signalling procedure, which is not in scope of this invention.

If the respective data packet is sent in several subblocks, then the subblocks can either be collected in step 202, until the whole data packet has been received, before the method proceeds with step 203, or steps 201 to 206 can be repeated for each of the subblocks.

FIG. 3 shows a method performed at the terminal of the user U1 for which the data is intended.

This method starts in step 301 to receive the data packet DP1 from the base station over the cellular network in step 302. In step 303 the data packets DP2 to DP4 are received from the other user terminals U2 to U4 over the ad-hoc network. It is also possible that steps 301 and 302 are executed in parallel or in opposite order, 302 first. Even if in steps 302 and 303 some data packets DP1 to DP4 are-missing, the method proceeds with step 304. In step 304 it is probed, whether all data packets DP1 to DP4 have been received. If not, the method continues with step 305 and tests for a time-out. If the time-out is reached in step 305, then the procedure performs an error procedure, as shown in step 306.

The error procedure in step 306 depends on the sort of data transferred between the base station and the user terminal. In a telephone consultation some missing data packets may not be a problem. But, if computer data is transferred, then even with the use of redundancy coding the lack of information may be so heavy, that reconstruction of the data is not possible, so that a request for a (partial) resending must be sent.

If no time-out occurs in step 305, then steps 302 and 303 are repeated.

When the data packets DP1 to DP4 are each sent as several subblocks, then in step 304 it is probed, if all subblocks of all data packets DP1 to DP4 have been received.

If step 304 is answered “yes”, then the data packets DP1 to DP4 received are combined in step 307. Then, the data is output in step 308 and the procedure ends (step 309).

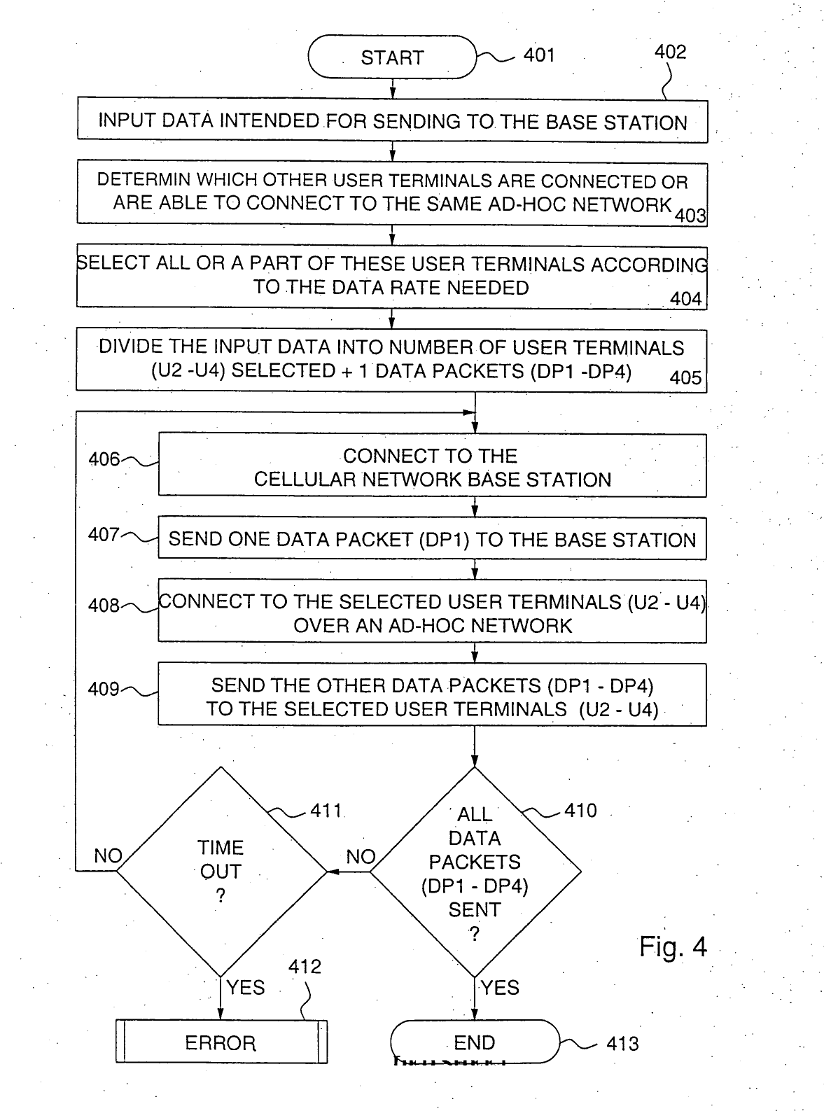

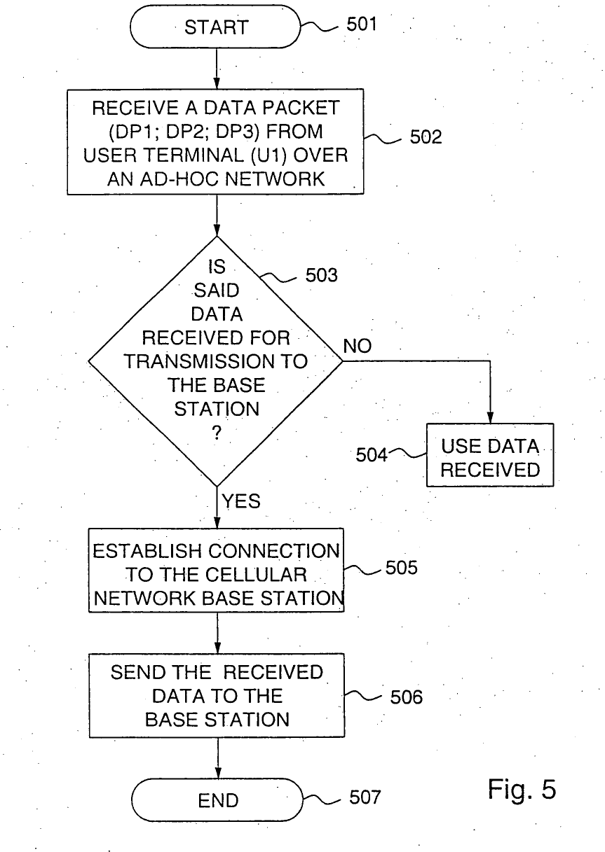

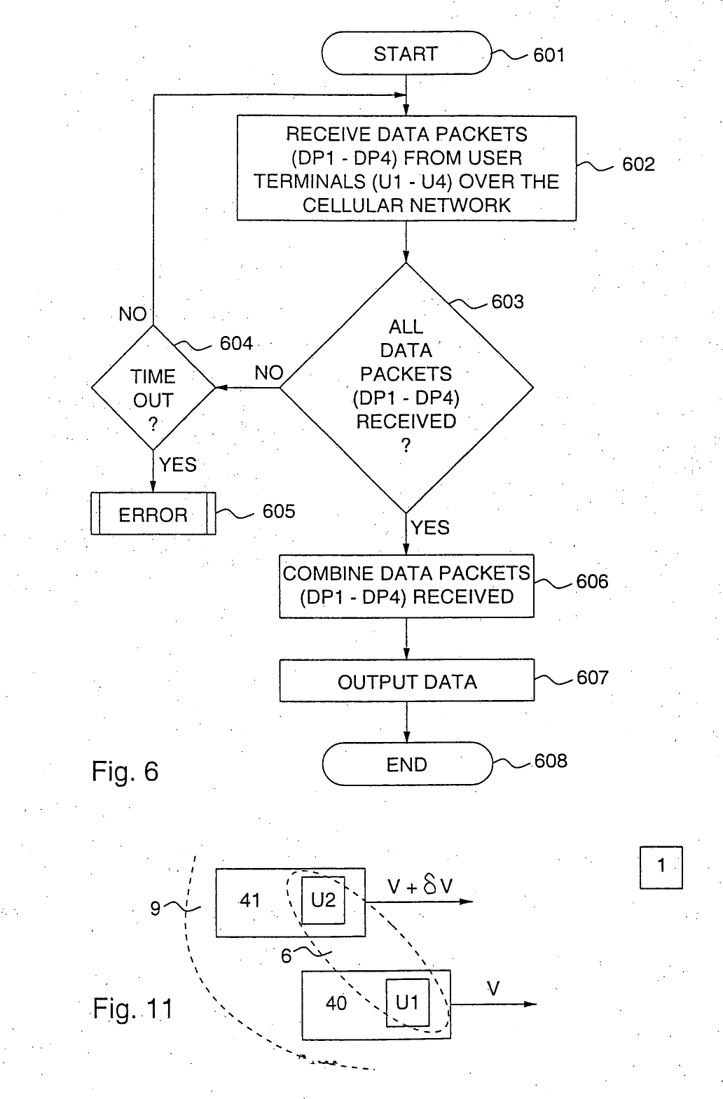

FIG. 4 to 6 show a method for sending data from a terminal to the base station of a cellular network according to a second embodiment of the invention (up-link). FIG. 4 shows the part of the method performed on the side of the user terminal which sends the data, FIG. 5 shows the steps on the side of a user terminal which is used as a transmission station, and FIG. 6 shows the steps performed on the side of the base station.

In FIG. 4 after the start of the method in step 401, the input data intended for sending to the base station is input in step 402. Then, in step 403 the terminal of the user determines which other user terminals are connected or are able to connect to the same second network, whereby in this embodiment the second network is a low-range ad-hoc network. Thereafter, as shown in step 404 all or a part of these user terminals are selected according to the data rate needed. Due to the low-range characteristic of the second network according to the second embodiment of the invention, user terminals that are close to the terminal of the user who intends to send the input data are preferably selected.

Step 404 is followed by step 405, in which the input data is divided into number of selected other user terminals U2 to U4 plus 1 data packets DP1 to DP4. Thereby, the additional data packet is intended to be sent directly from the user terminal to the base station. In another embodiment, in which the user terminal does not itself send a data packet directly to the base station, the input data is only divided into the number of data packets that corresponds to the number of other selected user terminals.

Then, a connecton is established between the user terminal and the cellular network base station in step 406. After connecting to the base station, the data packet DP1 is sent to the base station, as shown in step 407. Thereafter, the other selected user terminals U2 to U4 are connected over an ad-hoc network in step 408. Next, the other data packets DP2 to DP4 are sent to the selected other user terminals U2 to U4 in step 409. After performing steps 406 to 409, it is probed in step 410, whether all data packets DP1 to DP4 have been sent. If not, in step 411 a possible time-out is detected which time-out results in a jump to the error procedure shown in step 412. If no time-out occurs in step 411, then steps 406 to 409 are repeated, until all data packets have been sent, as probed in step 410. In this case, the procedure ends in step 413. Alternatively, step 407 may be performed only after steps 408 and/or 409. That is, the data packet DP1 may be sent to the base station only after the other user terminals have been selected and or after the other data packets have been sent to the other user terminals. It's also possible that steps 407 and 409 are done in parallel, so that all data packets DP1, DP2, DP3, DP4 are sent essentially in parallel.

The data packets DP1 to DP4 may also be sent as subblocks. Then, in step 410 it is determined, whether all subblocks of all data packets have been sent.

A time-out in step 411 may occur for several reasons. If a selected user terminal disconnects during the sending steps 406 to 409 then the respective-data packet can be sent to the base station or some other selected user terminal. Selecting a not yet selected user terminal from the users determined in step 403 is also possible. The unsent data packets can then be sent to this user terminal.

In FIG. 5 the method performed by a terminal of an user selected for sharing a data packet DP1; DP2; DP3 of the data according to the second embodiment of the invention is shown as a flow chart.

The method starts with step 501, and receives thereafter a data packet DP1; DP2; DP3 from user terminal U1 over the ad-hoc network, as shown in step 502. Thereafter, it is probed in step 503, whether that data received is for transmission to the base station. If not, then the data received is for the terminal itself and used accordingly, as shown in step 504. If the data received is for transmission to the base station, then step 505 follows, in which the connection is established between the terminal and the cellular network base station. Thereafter, as shown in step 506, the data received is sent to the base station over the cellular network connection and the procedure ends in step 507.

FIG. 6 shows the procedure performed by the base station as a part of the method according to the second embodiment of the invention as a flow chart.

The procedure shown in FIG. 6 starts with step 601. Then, the data packets DP1 to DP4 are received from the user terminals U1 to U4 via the cellular network, as shown in step 602. In step 603 it is determined, whether all data packets DP1 to DP4 have been received. If not, and if a time-out occurs, as probed in step 604, then the procedure jumps to an error routine shown in step 605. Until the time-out, step 602 is repeated.. In the error procedure shown in step 605, a request for resending a (specific) data packet DP1; DP2; DP3; DP4 can be sent to user-terminal U1. On the other hand, retransmission may not be necessary, for example in a telephone conversation or if that missing data can be reconstructed. The problem is the same as described with reference to step 306 in FIG. 3.

After all data packets have been received, step 606 follows, in which the data packets DP1 to DP4 received are combined together to the original data.

In step 607 this data is output, and the procedure ends in step 608.

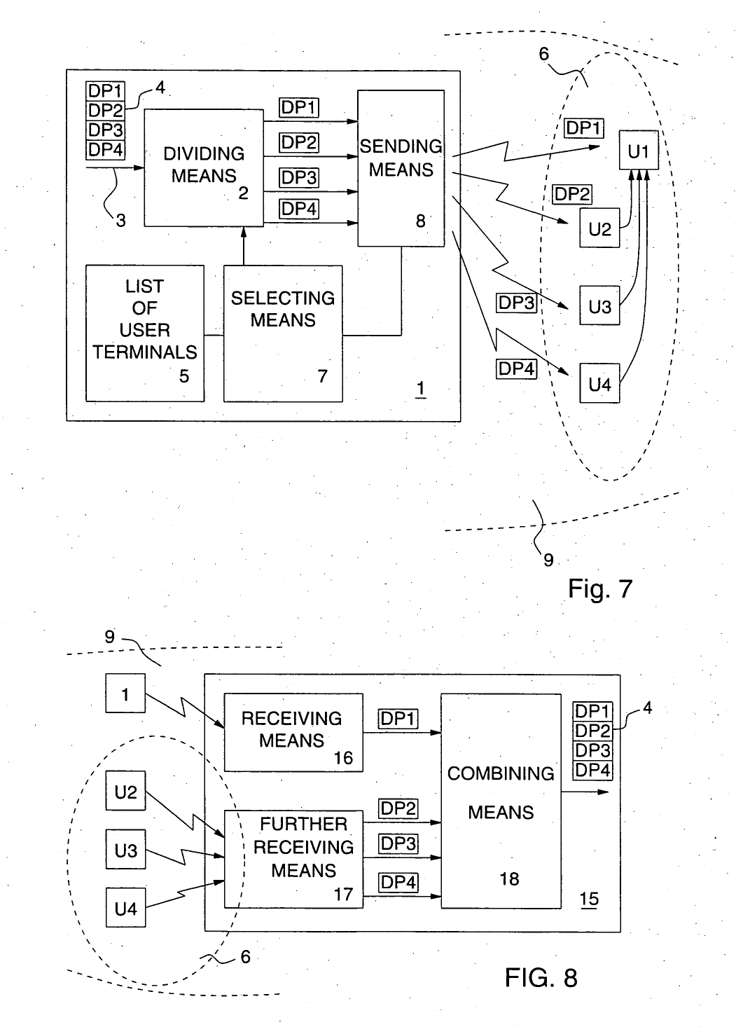

FIG. 7 shows base station and user terminals of the first embodiment of the invention.

The base station 1 comprises a dividing means 2. The dividing means 2 is connected with the input line 3 to input data 4 for the user terminal U1. The user terminals which are connected or are able to connect to user U1 over a second network 6 are listed in the list of user terminals 5. List of user terminals comprise user and/or terminal information which enables contacting the specific terminals which can be used according to this invention. This may include, for example in addition to terminal and/or user identification or contact information also such additional information as terminal capabilities information and application or service useability, allowance and/or restriction information. As an example, in the first embodiment of the invention the user terminals U2, U3 and U4 are listed in the list of user terminals 5. It should be understood, that the list of user terminals 5 may also reside outside the base station, as far as the information of the available terminals for connection is available for the base station when needed. In this exemplary embodiment, this list is provided within the base station. This information may thus also be provided from a remote list which is made available over an interface to the other related functions in the base station. The list of user terminals 5 is connected with a selecting means 7. In this example, to transmit the data 4 in time, four times the data rate of a single base station to user terminal connection is needed. Hence, the selecting means 7 select user terminals U2, U3 and U4. The number+1 and contact information of selected user terminals is sent from the selecting means 7 to the dividing means 2. The selected user terminal information for U2, U3 and U4 are input from the selecting means 7 to a sending means 8. The dividing means 2 divides the data 4 in at least two parts. The number of parts depends on the number input from the selecting means 7. In the example the dividing means 2 divides the data 4 in four data packets DP1 to DP4. The data packets DP1 to DP4 are sent from the dividing means 2 to the sending means 8. The sending means 8 connects to user terminals U1 to U4 over the cellular network 9 and sends the data packets DP1 to DP4 to the respective user terminals. Thereby the data packets DP1 to DP4 are sent essentially in parallel.

Then, user terminals U2 to U4 connect to the user terminal U1 over the second network 6 and send the data packets DP2 to DP4 to user terminal U1. According to another optional embodiment, the connection between terminals U1 and other terminals U2 to U4 is established already at the time of sending the data packets DP1 to DP4.

FIG. 8 shows the receiving of the data packets DP1 to DP4 according to the first embodiment of the invention in greater detail. In this and all other figures corresponding:parts are referred to by identical reference numbers.

The receiving part 15 of user terminal U1 comprises a receiving means 16 which is adapted to receive data sent over the cellular network from base station 1. Further, the receiving part 15 comprises a further receiving means 17 which is adapted to receive data from other user terminals via the second network 6 essentially in parallel. This kind of arrangement can be done for example in a multi-carrier system, for example OFDM, so that some number of the sub-carriers are allocated to each sending user terminal U2, U3, U4, and the receiving user terminal U1 receives all sub-carriers at the same time. Or, in a time division system one time slot is allocated to each sending user terminal U2, U3, U4, and the receiving user terminal U1 receives all required time slots.

Hence, the receiving means 16, 17 receive the data packets DP1 to DP4 at most in parallel, and forward them to a combining means 18 for combining the data packets DP1 to DP4 to their original data 4.

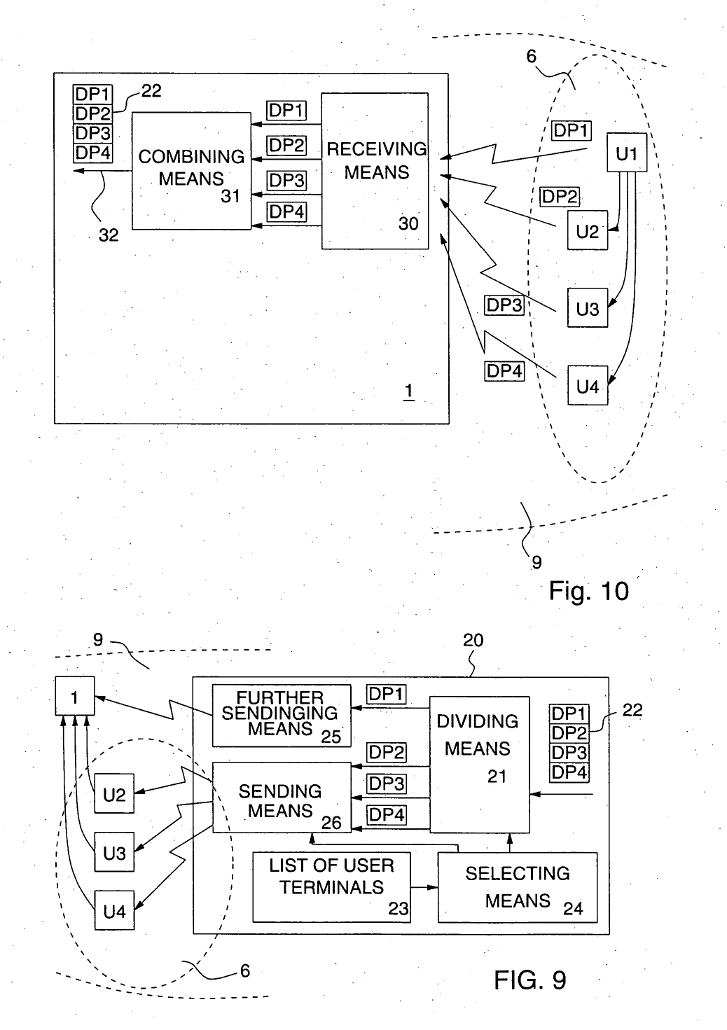

FIG. 9 shows a terminal of a user sending data to the base station according to the second embodiment of the invention.

The sending part 20 of user terminal U1 comprises a dividing means 21. Data 22 is input to the dividing means 21. In a list of user terminals 23 of the sending part 20 the user terminals are listed, which are connected or are able to connect to the same second network as user terminal U1. A selecting means 24 selects, as an example of this embodiment, user terminals U2 to U4 from the list of user terminals 23, because the amount of data 22, is four times the amount of data that can be sent in time through a single connection over the cellular network so that four user connections to the base station 1 are needed to achieve the preferred data rates.

The dividing means 21 divides the data 22 in the data packets DP1 to DP4 in line with the number of user terminals selected plus 1, which is sent from the selecting means 24 to the dividing means 21. The dividing means 21 sends one data packet DP1 to the further sending means 25, whereby the further sending means 25 sends the data packet DP1 to the base station 1 over the cellular network 9.

The other three data packets DP2 to DP4 are sent from the dividing means 21 to the sending means 26, and the sending means 26 sends this data packets essentially in, parallel to the user terminals U2 to U4 over the second network 6. This kind of arrangement can be done for example in a multi-carrier system, for example OFDM, so that some number of the sub-carriers are allocated to each sending user terminal U2, U3, U4, and the sending user terminal U1 transmits data on all sub-carriers at the same time. Or, in a time division system one time slot is allocated to each receiving user terminal U2, U3, U4, and the sending user terminal U1 transmits in all applicable time slots.

Then, user terminals U2 to U4 send the respective data packets DP1 to DP4 to the base station 1 of the cellular network 9.

FIG. 10 shows the receiving of the data-by the base station 1 according to the second embodiment of the invention, whereby the base station 1 is shown in greater detail.

User terminal U1 sends the data packet DP1 directly over the cellular network 9 to the base station 1 and data packets DP2 to DP4 over the second network 6 to users U2 to U4, and user terminals U2 to U4 thereafter send (forward) the data packets DP2 to DP4 to the base station 1 of the cellular network 9, as described according to FIG. 9.

The base station, 1 comprises a receiving means 30 to receive the data packets DP1 to DP4 from user terminals U1 to U4. The receiving means 30 sends those data packets DP1 to DP4 to a combining means 31 for combining the data packets DP1 to DP4 to the original data 22, which data 22 is output at output 32.

FIG. 11 shows a third embodiment of the invention.

In FIG. 11 a user is moving with his user terminal U1, for example in a car 40, with velocity v. Another user is moving with his user termial U2, for example in another car 41, with velocity v+δv. Both user terminals are connected to the cellular network 9. If both user terminals U1, U2 drive in the same direction on a motor highway, then the difference δv between their velocities is small. If the user terminal U2 is idle and user terminal U1 needs a higher data rate to the base station of the cellular network 9, then user terminal U1 can take advantage of the idle user terminal U2. User terminals U1 and U2 are close to each other and the relative speed δv between them is small so that spectral efficient transfer methods can be used between them by a local ad-hoc network. Hence, the data rate between user terminals U1 and U2 can be much higher than the data rate of a single connection between user terminal U1 or U2 and the base station of the cellular network 9. Hence, the overall data rate is not limited by the transmission between user terminals U1 and U2 and twice the data rate of a single connection over the cellular network 9 can be provided.

Therefore, it is advantageous that, for example in step 104 (FIG. 1) of the first embodiment of the invention and step 404 (FIG. 4) of the second embodiment of the invention, user terminals with nearly the same velocity and direction of movement are selected. Other examples are user terminals moving together in a same bus or train. Although first and second embodiment of the invention have been described with four user terminals, it will be apparent that an arbitrary number of user terminals can be involved. Further, the data can be sent in several subblocks, for example if the amount of data is large. If the number of user terminals involved is increased, the portion of the connection between the user terminal which receives the data in the end and the base station is reduced. Therefore, even if the direct transmission to the receiving user terminal is omitted a large overall data rate can be achieved.

Further, instead that the local transfer utilizes an ad-hoc network, an other embodiment of the invention is to build a transceiver station, which station comprises many mobile terminals with wired or wireless links between them and one terminal is acting as a controller. Thereby, the links are used to transfer the data as a multipoint-to-point and/or point-to-multipoint fashion. The advantage of this control is that it enables to use the other terminals as virtual transceivers in multiple input multiple output (MIMO) systems, where there are multiple transmit antennas and multiple receive antennas.

In the preferred embodiments of the invention it is advantageous that the data packets are sent and/or are received essentially in parallel. In a transfer system, in which each of the terminals sends and receives in its own time slot, parallel means that the data packets are distributed to be sent and/or received nearly at the same time. Then, essentially parallel is to be understood in the way that the overall data rate is larger than the data rate available for a single connection between a cellular base station and a terminal.

1-36. (canceled)

37. A base station of a cellular network comprising:
a dividing means for dividing data intended for a terminal into data packets;
a selecting means for selecting at least one of other terminals of said cellular network which are connected to or are able to connect to said terminal over a second network; and
a sending means for sending at least one of said data packets to said other terminals selected by said selecting means over said cellular network, whereby the data packet is sent to said selected other terminals for forward transmission to said terminal over said second network.

38. A base station according to claim 37, wherein said sending means sends at least one data packet to said terminal for which the data is intended.

39. A base station according to claim 38, wherein said data packets are sent essentially in parallel to said terminal and said other terminals selected.

40. A base station according to claim 37, wherein said selecting means selects said other terminals of the cellular network which are near the terminal for which the data is intended.

41. A base station according to claim 37, wherein said selecting means selects other terminals of the cellular network which are moving together with the terminal for which the data is intended.

42. A base station of a cellular network comprising:
a receiving means for receiving data packets from terminals over the cellular network; and
a combining means for combining the data packets that have their origin in a specific terminal, whereby at least a part of said data packets is transmitted from said specific terminal to at least one other terminal over at least a second network.

43. A base station according to claim 42, wherein said receiving means receives at least one data packet from said specific terminal and said combining means combines the at least one other data packet transmitted from at least one other terminal and having its origin in said specific terminal with said data packet received from said specific terminal.

44. A base station according to claim 42, wherein said combining means is adapted to receive said data packets at most in parallel.

45. A terminal of a cellular network for receiving data which is divided into at least two data packets sent to different terminals of the cellular network over said cellular network, said terminal comprises:
a receiving means for receiving at least one of said data packets from an other terminal of said cellular network over a second network, and
a combining means for combining said data packets.

46. A terminal according to claim 45, comprising a further receiving means for receiving at least one data packet from a base station of said cellular network over said cellular network, whereby this data packet is received essentially in parallel to the other data packets received by said receiving means over said second network.

47. A terminal according to claim 45, wherein said receiving means is adapted to receive said data packets received over said second network essentially in parallel.

48. A terminal according to claim 45, wherein said second network is a wireless network.

49. A terminal according to claim 48, wherein said second network is an ad-hoc network.

50. A terminal according to claim 45, wherein said second network has a higher average useable data rate than the cellular network.

51. A terminal according to claim 50, wherein said second network is a low-range network so that the second network is limited to nearby terminals.

52. A terminal according to claim 50, wherein said second network is limited to terminals moving together.

53. A terminal according to claim 45, wherein said terminal is part of a transceiver station, whereby said transceiver station comprises said other terminals connected to said terminal over said second network, and
links over the second network between said terminal and said other terminals are used to transfer said data packets in a multipoint-to-point fashion to said terminal.

54. A terminal of a cellular network for sending data to a base station of a cellular network comprising:
a dividing means for dividing data intended to be sent to said base station of said cellular network into data packets,
a selecting means for selecting other terminals of said cellular network which are connected or could be connected to the said terminal over a second network,
a sending means for sending at least one data packet to said selected other terminals over said second network, whereby the data packet is sent to said other terminals for forward transmission to said base station over the cellular network.

55. A terminal according to claim 54, comprising a further sending means for sending at least one data packet to the base station of said cellular network over said cellular network, whereby this data packet is sent essentially in parallel to the other data packets sent by said sending means over said second network.

56. A terminal according to claim 54, wherein said sending means is adapted to send said data packets over said second network to said other terminals essentially in parallel.

57. A terminal according to claim 54, wherein said second network is a wireless network.

58. A terminal according to claim 57, wherein said second network has a higher average useable data rate than the cellular network.

59. A terminal according to claim 58, wherein said second network is a low-range network so that the second network is limited to nearby terminals.

60. A terminal according to claim 57, wherein said second network is limited to terminals moving together.

61. A terminal according to claim 54, wherein said terminal is part of a transceiver station, whereby said transceiver station comprises said other terminals connected to said terminal over said second network, and
links over the second network between said terminal and said other terminals are used to transfer said data packets in a point-to-multipoint fashion to said other terminals.

62. A method for sending data from a base station of a cellular network to a specific terminal comprising the steps of:
a) dividing said data into data packets;
b) selecting other terminals of said cellular network which are connected to or are able to connect to said specific terminal over a second network;
c) sending a portion of said data packets from said base station to said other terminals over said cellular network;
d) sending said data packets from said other terminals to said specific terminal over said second network;
e) receiving the portion of said data packets send from said other terminals by said specific terminal;
f) combining said data packets received to retrieve said data.

63. A method according to claim 62, comprising the further steps of
b2) selecting said specific terminal;
c2) sending one data packet from the base station to said specific terminal over said cellular network; and
e2) receiving said data packet sent from the base station by said specific terminal.

64. A method according to claim 62, wherein said data packets are received essentially in parallel.

65. A method according to claim 62, wherein said second network is a wireless network.

66. A method according to claim 65, wherein said second network is an ad-hoc network.

67. A method according to claim 65, wherein said second network is a low-range network.

68. A method according to claim 62, wherein said terminal is part of a transceiver station, whereby said transceiver station comprises said other terminals connected to said terminal over said second network and
links over the second network between said terminal and said other terminals are used to transfer said data packets in a multipoint-to-point fashion to said terminal.

69. A method for sending data from a specific terminal of a cellular network to a base station comprising the steps of:
a) dividing said data into data packets;
b) selecting other terminals of said cellular network which are connected or could be connected to the said terminal over a second network;
c) sending at least a portion of said data packets from said specific terminal to said other terminals over said second network;
d) receiving said data packets sent over said second network by said other user terminals;
e) transmitting said data packets received from said other terminals to said base station over said cellular network;
f) receiving said data packets sent over the cellular network by the base station; and
g) combining said data packets sent over the cellular network to retrieve said data.

70. A method according to claim 69, comprising the further step of:
c1) sending at least one data packet from said specific terminal to the base station over the cellular network.

71. A method according to claim 69, wherein said data packets sent over the cellular network are received essentially in parallel.

72. A method according to claim 69, wherein said second network is a wireless network.

73. A method according to claim 72, wherein said second network is an ad-hoc network.

74. A method according to claim 72, wherein said second network is a low-range network.

75. A method according to claim 69, wherein said terminal is part of a transceiver station, whereby said transceiver station comprises said other terminals connected to said terminal over said second network and
links over the second network between said terminal and said other terminals are used to transfer said data packets in a point-to-multipoint fashion to said other terminals.
